(19) United States
(12) Patent Application Publication
(10) Pub. No.: US 2010/0232960 A1
(43) Pub. Date: Sep. 16, 2010

(54) VARIABLE GEOMETRY TURBINE

(76) Inventor: Christopher Larsen, Toronto (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 12/723,056

(22) Filed: Mar. 12, 2010

Related U.S. Application Data
(60) Provisional application No. 61/159,835, filed on Mar. 13, 2009.

(51) Int. Cl. F03B 3/12

(52) U.S. Cl. 416/23; 416/241 R

(57) ABSTRACT

There is provided a turbine having rotating blade surfaces that adjust their geometry based on incident fluid flow. In one aspect, there is provided a turbine having a least one pair of blades rotatably connected such that their geometry is adjusted based on incident fluid flow. In another aspect, there is provided, a turbine having at least one pair of blades connected such that they self-orient themselves to a neutral position under their own weight. In yet another aspect, there is provided, a control surface for a turbine blade which prevents meta-stable stall of the turbine blade in an fluid stream.

This application claims priority from U.S. Provisional Application No. 61/159,835 filed on Mar. 13, 2009, the contents of which are incorporated herein by reference.

### TECHNICAL FIELD

The following relates generally to turbines and more particularly to a turbine having variable geometry.

### BACKGROUND

There is a need to provide a turbine that produces greater or more efficient power output than conventional propeller turbines, in particular at lower fluid speeds and at lower revolutions per minute (RPM).

### SUMMARY

There is provided a turbine having rotating blade surfaces that adjust their geometry based on incident fluid flow. In one aspect, there is provided a turbine having a least one pair of blades rotatably connected and with such geometry such that incident fluid flow reorients their aspect to said fluid flow to the effect of rotating the entire structure with imparted force and energy. In another aspect, there is provided, a turbine having at least one pair of blades connected such that they self-orient themselves to a neutral position under a centering, biasing force such as their own weight or a spring which is amenable to initial or further reorientation by the fluid flow. In yet another aspect, there is provided, a control surface for a turbine blade which prevents meta-stable stall of the turbine blade in an fluid stream to the effect of continued rotation.

### BRIEF DESCRIPTION OF THE DRAWINGS

Embodiments of the invention will now be described by way of example only with reference to the appended drawings wherein:

FIG. 1 is a perspective view of a turbine blade.

FIG. 2 is a perspective view of a turbine having rotating blades that adjust their geometry based on incident fluid flow.

FIG. 3 is a perspective view of another embodiment of a turbine having rotating blades.

FIG. 4 is a perspective view of a turbine showing incident fluid flow with respect to a pair of oppositely positioned blades.

FIG. 5 is graph showing fluid speed versus power output advantage for the variable geometry turbine.

FIG. 6 is a perspective view of a series of turbine assemblies in a stacked configuration.

FIG. 7 is a schematic diagrams illustrating drag based forces acting on the variable geometry turbine.

FIG. 8 shows the mechanism of conventional turbine blades.

FIGS. 9 to 11 are schematic diagrams illustrating retreating and leading blade aspects.

FIGS. 12 and 13 are schematic diagrams illustrating a series of blade profiles exhibiting different drag coefficients.

FIGS. 14 and 15 are diagrams illustrating retreating and leading blade aspects.

FIG. 16 is a schematic diagram of a turbine blade in a neutral position.

FIG. 17 is a schematic diagram of a turbine blade in a deployed position.

### DETAILED DESCRIPTION OF THE DRAWINGS

It has been recognized that by providing a turbine having rotating blade surfaces that adjust their geometry based on incident fluid flow, more power can be generated from the turbine at all fluid speeds. A turbine is described below that has a least one pair of blades rotatably connected such that their geometry causes reorientation by the incident fluid flow. The turbine's blades may be connected such that they self-orient themselves to a neutral position under their own weight or a self centering force such as a centering spring, and may utilize a control surface which prevents meta-stable stall of the turbine blade in an fluid stream.

It may be noted that although the following examples are, for illustrative purposes, directed to embodiments wherein the turbine is operated on by a moving airstream, the principles discussed herein are equally applicable to any moving fluid such as water, etc.

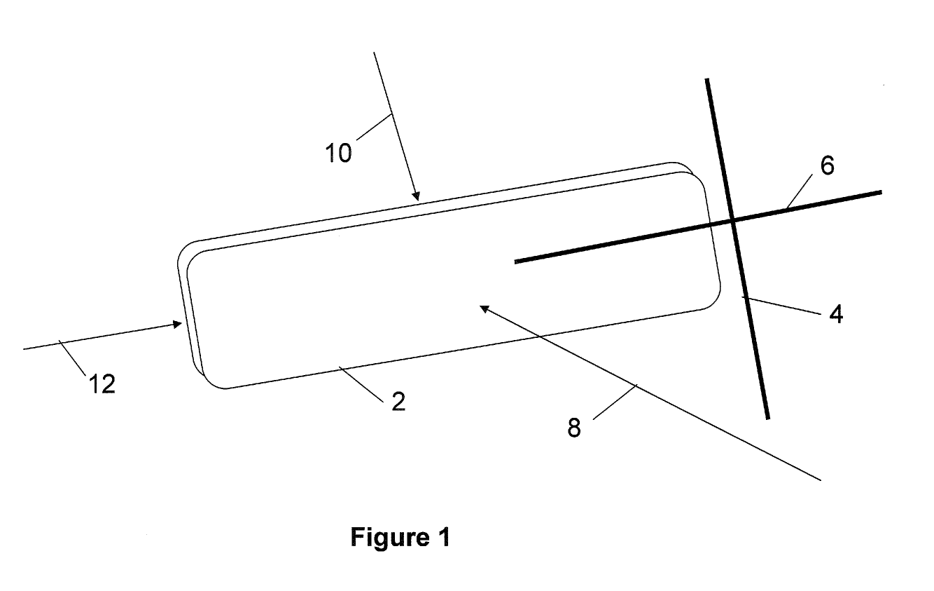

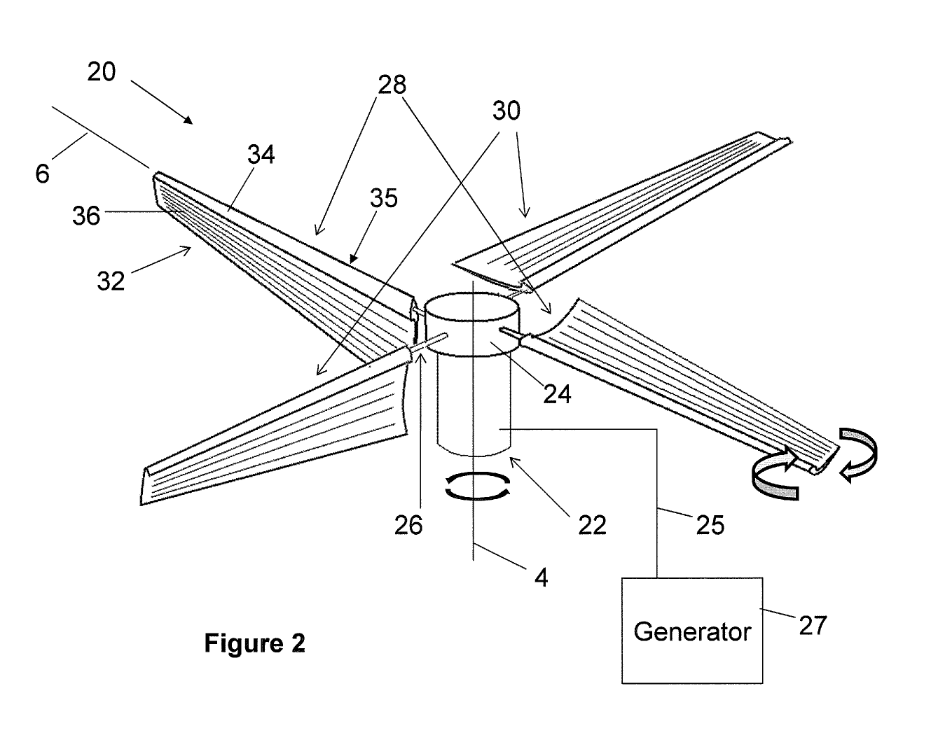

In order to facilitate discussion of the proposed turbine assemblies 20 described herein, the following aerodynamic characteristics affecting the turbine assemblies 20 discussed herein, will be provided making reference to FIGS. 1 and 2.

In the examples described herein, a turbine assembly 20 with radial blades 32 may be connected pivotally, either directly or indirectly, to the turbine's main output shaft 22 which rotates horizontally about a vertical axis 4. The radial blades 32 in this example are further capable of rotating about their long axis 6, each of which extends radially from the turbine hub 24. The turbine assembly 20 shown in FIG. 2 comprises a first pair of oppositely positioned blades 28 and a second pair of oppositely positioned blades 30. Each blade 32 is connected to the turbine hub 24 via a rotatable connection rod 26. This enables the blades 32 to rotate about their long axis 6 at the same time as rotating about the turbine's vertical axis 4. The rotation of the hub 24 in turn rotates the turbine shaft 22, which in turn can power a generator 27 via a connection 25 as is well known in the art. The blades 32 in this example each comprise an upper edge 34 which is generally aligned with and along the respective long axis 6 such that rotation of the rod 26 in turn rotates the entire blade 32 about the edge 34. Each blade 32 also comprises a primary blade surface 36.

The primary blade surface 36 is presented by the turbine blade 32 such that it substantially faces a perpendicular fluid stream when moving in a direction with the fluid stream. The primary blade surface 36, due to the rotatable nature of the blade 32 is oriented farther from perpendicular when moving in a direction opposite the fluid stream. The primary blade surface 36 has, in a moving airstream, a higher aerodynamic drag coefficient (Cd) when oriented closer to perpendicular with the airflow. The surface orientation wherein the primary blade surface 36 is close to perpendicular with respect to the airstream's motion vector as shown in FIG. 1, may be described as “In-Opposition” 8. Conversely, the primary blade surface 36 has a lower Cd when oriented further away from the airflow normal. Such a surface orientation with respect to the airstream motion vector may be described as “In-Line” 10 as shown in FIG. 1. The primary blade surface 36 also has a lower Cd when axially oriented closer to or opposite the airstream motion vector. Such a surface orientation with respect to the airstream motion vector may be described as “End-Off” and “End-On” respectively, wherein “End-On” 12 is shown in FIG. 1.

It can be appreciated that the power output of the turbine assembly 20 and the blades 32 may be described herein as the torque and angular rotation speed of the turbine's main shaft 22, under the influence of an airstream, or other kinetic fluid medium. This mechanical power is separate and distinct from the electrical power output of the turbine assembly 20, which is zero unless the mechanical power output is used as the input to the electrical generator 27 which, this example can convert the output to AC or DC power, or mechanical work. This configuration, however, is only one implementation, and further a gearbox with an asynchronous electrical generator 27 is a type that is also suited to the implementation of the embodiments described herein.

A second blade surface, opposite of the primary blade surface 36, the oppositely facing surface 35 to the primary blade surface 36, may or may not, in certain circumstances, compliment the primary blade surface 36 by further amplifying the change in Cd of the blade 32 due to the airstream's orientation. When the oppositely facing surface 35 is oriented In-Opposition 8 to the airstream, it may exhibit a lower Cd, and reduce torque imparted to the turbine assembly 20, opposite to the desired direction for turbine rotation that provides power output.

The primary blade surface 36 may be configured to utilize a surface treatment, thus further increasing the Cd. Such treatments may comprise concave slots, hemispherical indentations, textures, meshing, grain or ribs. Similarly the oppositely facing surface 35 can be provided with a treatment that should reduce its Cd by using smooth, low-friction coatings, films, spoilers or vortex generators. The shape of the oppositely facing surface 35 should minimize laminar airflow over the primary blade surface 36 that would otherwise increase the Cd of the primary blade surface 36 when in the “End-On” 12 and “In-Line” 10 orientations.

It can therefore be appreciated that described herein are connected rotating blades 32 having surfaces 36, 35 the geometrical relationship of the blade-pair 28, 30 causes their orientation to change based on direction of incident airflow. This orientation, away from the neutral position, has the characteristic of resulting in a substantially different coefficient of drag for each blade 32 of the blade-pair 28, 30 in that airflow. This results in a useful torque caused about the axis of the blade-pair 28, 30 which rotates. The orientation motion importantly and efficiently uses the mediums own kinetic energy for the motion, which is stored as potential energy. Also described and shown is a self-orientation of a wind turbine blade 32 back to a neutral position that can be achieved using a center biasing force such as gravity or springs. This second return motion importantly and efficiently uses the stored potential energy, extracted from the mediums own kinetic energy. Further described and shown is a control surface 38 (see also FIG. 3) to prevent meta-stable stall of the turbine blade 32 in an airstream.

The advantages provided by the three above-described aspects include:

a) lower cost per kW power produced at the shaft 22;

b) higher power production per kg turbine mass;

c) the ability to provide close vertical stacking of multiple turbine assemblies 20;

d) reduced horizontal spacing for multiple installations when vertically stacked;

e) reduced generator mass requiring support by a turbine tower;

f) reduced bending stress exerted on such a supporting tower;

g) higher power extracted from a moving air stream per square meter of normal projected blade area, also per kg supported mass, and per m/s of air stream velocity;

h) lower blade speed and turbine RPM for equivalent power from industry conventional horizontal-axis and vertical-axis type designs; and

i) high efficiency of power extracted from an airstream per kg of the turbine assembly 20 and per square meter of normal projected blade area.

In terms of the rotating blade surfaces 36, 35 that adjust their orientation, it has been recognized that the blade surfaces 36, 35 change, or are changed, in orientation, depending on it's relative motion with or against the airstream direction as can be seen in FIG. 2. This change is effected on the blade 32 in part or in whole by either an externally applied torque on the blade's long axis 6, or by allowing the blade 32 to rotate pivotally on the axis 6 due to a torque imparted on the blade 32 by the force exerted on the blade 32 by the airstream 40. In an airstream, the net torque applied to the turbine's main shaft 22 is increased due to a higher trailing blade Drag Coefficient, Cd (e.g. the vertically oriented blade of pair 28 shown in FIG. 2) and a lower leading blade Cd (e.g. the horizontally oriented blade of pair 28 shown in FIG. 2) achieved by changing the blade's angle of rotation about the long axis 6.

In the configuration shown in FIG. 2, each blade 32 is paired with a matching blade opposite the rotational center of the turbine hub 24, such that a force applied by the airstream to one blade 32 is also applied to the paired blade 32. These set of blades 32 are connected to the hub 24 with an offset angle with respect to the next blade that is greater than 0 degrees but less than 180, but ideally closer to 90 degrees of offset. The torque generated in the blade 32, or blade pair 28, 30, is affected by that blade's orientation to the airflow.

A change in the blade's orientation positions the blade 32 in an orientation with a higher Cd when In-Opposition 8, as compared to the Cd for the surface when in it's neutral, unbiased position, and/or not subjected to external forces such as a zero velocity airstream condition. For a retreating blade, this rotation changes the angle of incidence of the airstream on the surface, away from In-Line 10 and/or End-On 12, and closer to In-Opposition 8 (the high Cd orientation). For a leading blade, this rotation changes the angle of incidence of the airstream on the surface, away from In-Opposition 8 and/or End-Off, and closer to In-Line 10 (the low Cd orientation)

In terms of self-orientating to a neutral position, reference may also be made to FIG. 2. In the absence of sufficient airstream velocity, the blade may preferably re-orient itself under gravity or self centering bias force such as a centering spring, to a neutral mid-point position. The omni-directional nature of the turbine assembly 20 shown in FIG. 2 precludes any requisite external alignment of the turbine according to airstream direction, and the blade rotation can be and is ideally effected solely by the airstream and its direction. The center of gravity for the blade 32 should be selected to cause rotation of the primary blade surface 36 into that surface's high Cd. Higher airstream velocity causes rotation beyond the optimal orientation, lowering the Cd of the trailing blade, and/or increasing the Cd of the leading blade. This effect decreases turbine power generation efficiency, lowers force and stress in the blade 32 or turbine assembly 20 that might otherwise cause damage to the turbine assembly 20. This effect is advantageous at high wind velocities, preventing damage and permitting longer continued function at higher velocities before the turbine assembly 20 would typically be locked-down or otherwise protected from harm.

In alternate configurations, the blade 32 may be linked by an intermediary connecting member (not shown), such as a gear or other force/torque transmitting member, to other similar blades 32 on the turbine assembly 20 at a different blade axial rotational angle to the turbine center. By such connection axial rotation of one blade pair 28, 30 axially rotates all blade-pairs 28, 30.

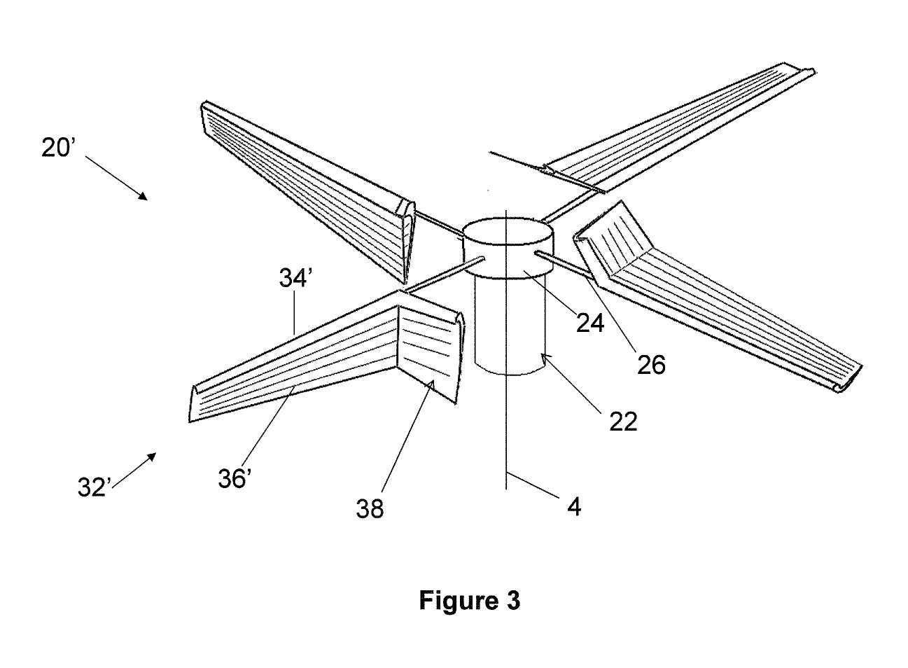

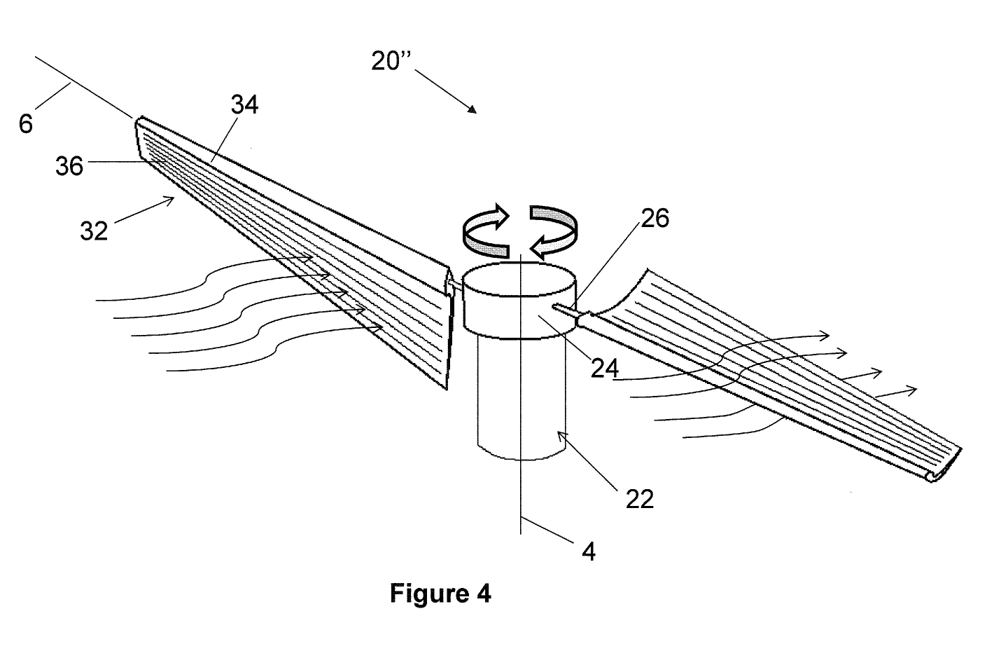

Turning now to FIG. 3, details of a control surface 38, which may be used to prevent meta-stable stall of the turbine blade 32 in an airstream, will now be described. Another improvement to the turbine assembly 20 shown herein is the addition of the control surface 38 to the blade 32. The control surface 38 can be integral to or be separate from the primary blade surface 36. The orientation of the control surface 38 results in a torque or moment on the blade 32 about it's long axis of rotation 6 when the blade is close to the angle of transition from being a trailing blade to being a leading blade, and also the angle of transition from leading blade to trailing blade. The control surface 38 is effective in facilitating the operation of 2-Blade versions of the turbine assembly 20 (as can be seen in FIG. 4), preventing a meta-stable state in the End-On 12 orientation of the primary blade surfaces 36. The control surface 38 may or may not contribute to the same function as the primary blade surface 36 depending on the blade's orientation, but advantageously does so in a preferred configuration. The control surface 38 may channel incoming airflow away from the turbine main axis 4 to impinge the primary blade surface 36 area at a greater distance from the turbine axis 4 resulting in higher torque being applied by the blade 32 to the turbine main shaft 22.

Turning now to FIG. 4, operation of a wind turbine as described above, is shown having a single pair of oppositely oriented blades 32. The configuration shown in FIG. 4 can produce higher torque output than conventional propeller turbines at low RPM, and particularly at low wind speeds, and can generate more power at all wind speeds. One advantage of the design described herein is the smaller diameter for an equivalent blade surface area. Another advantage is the omni-directional aspect of the design, which can generate more power without changing directions. Also, the lower RPM operation speed should be safer for birds and have quieter operation. The lower start-up speed generates more power for more of the time, and low efficiency at high wind speeds can promote self-preservation. Furthermore, the less supported weight typically means more mass available for larger blades 32, and more power output per unit of weight of supported mass can translate into lower cost per power (cost ratio). It can be appreciated that more power typically translates to better cost output per unit.

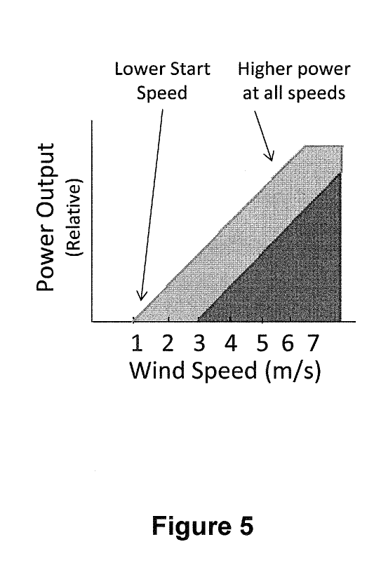

As illustrated in the chart shown in FIG. 5, the design shown herein is designed for maximum torque at lower wind speeds, such as 1 m/s. In this way, the turbine assembly 20 can generate power in conditions where conventional turbines that need greater minimum airflow speed to start-up, such as 2.5 to 3 m/s. With lower RPM operational speed, the wind velocity relative to the moving, or retreating, blade 32 is better preserved. More torque for more of the time means more power output.

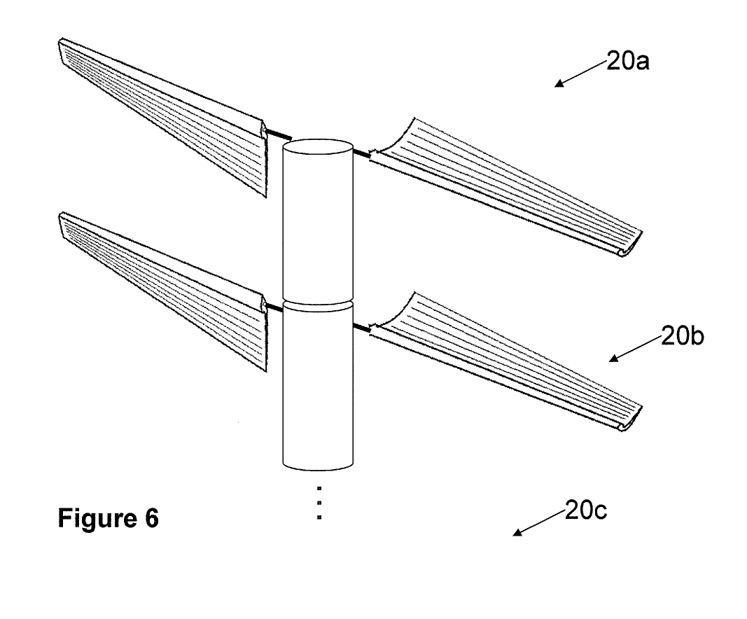

By having a high utilization of swept area, the turbine assemblies 20 as shown herein can be stacked vertically as shown in FIG. 6, instead of being separately spaced apart such as in wind farms. This permits a smaller footprint per unit. The lower blade tip velocity precludes use of special high heat materials such as fiberglass, which can also effect a lower cost. The low RPM means a quieter unit, and shorter mast required for the blade-to-ground clearance means lower cost, and the ability to have building-top applications. The horizontally rotating blades 32 can also reduce bending moments on the mast 22. The blades 32 can also be foldable for high wind protection by matching blade alignments or for stowage. This also promotes self-preservation from extreme conditions. The shorter blades 32 also mean that the turbine assemblies 20 are easier to transport to a site.

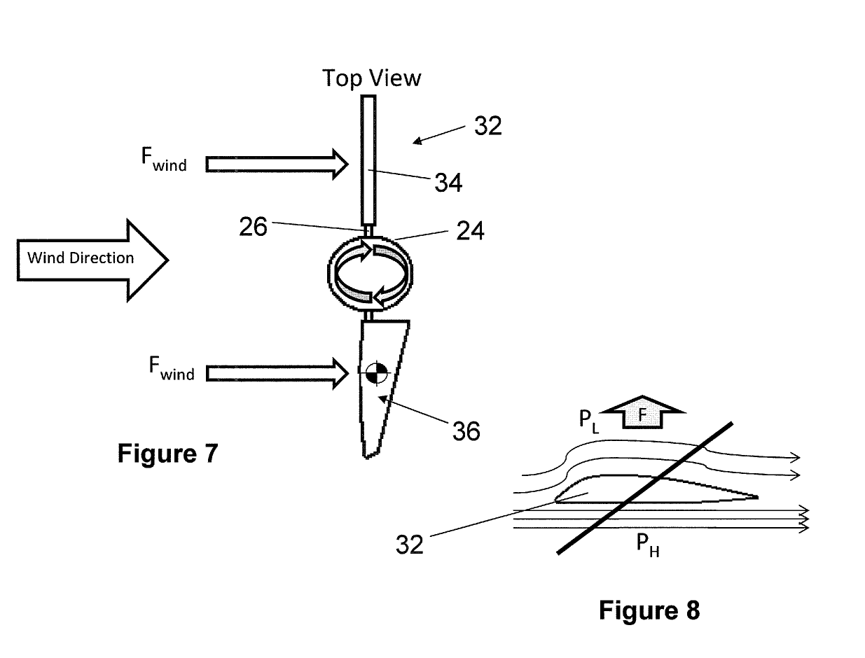

As shown in FIGS. 7 and 8, the turbine assembly 20 works based not on the principles of airfoil lift, as in most conventional 3-blade horizontal axis turbines, but rather on the difference in drag coefficient Cd between the leading and trailing blades. The force of the wind F_{wind} applied to the retreating or trailing blade 32 (shown edgewise in FIG. 7) can be approximately computed as follows: F_{retreating}0.5×ρ×Area_{retreating}×ν²^{_{wind}}×Cd_{retreating}. The force of the wind F_{wind} applied to the leading blade 32 (shown in plan view in FIG. 7), can be computed as follows: F_{leading}=0.5×ρ×Area_{leading}×ν²^{_{wind}}×Cd_{retreating}. In this example, σ=air density (typically 1.2 kg/m³). Consequently, the output torque can be computed as follows: Torqueₒᵤₜₚᵤₜ=L_{retreating}×F_{retreating}−L_{leading}×F_{leading}, wherein L=axis to blade area centroid distance. This is in contrast to FIG. 8 which shows how conventional blades create high and low pressure differential via the airfoil or wing effect which imparts motion to the blade.

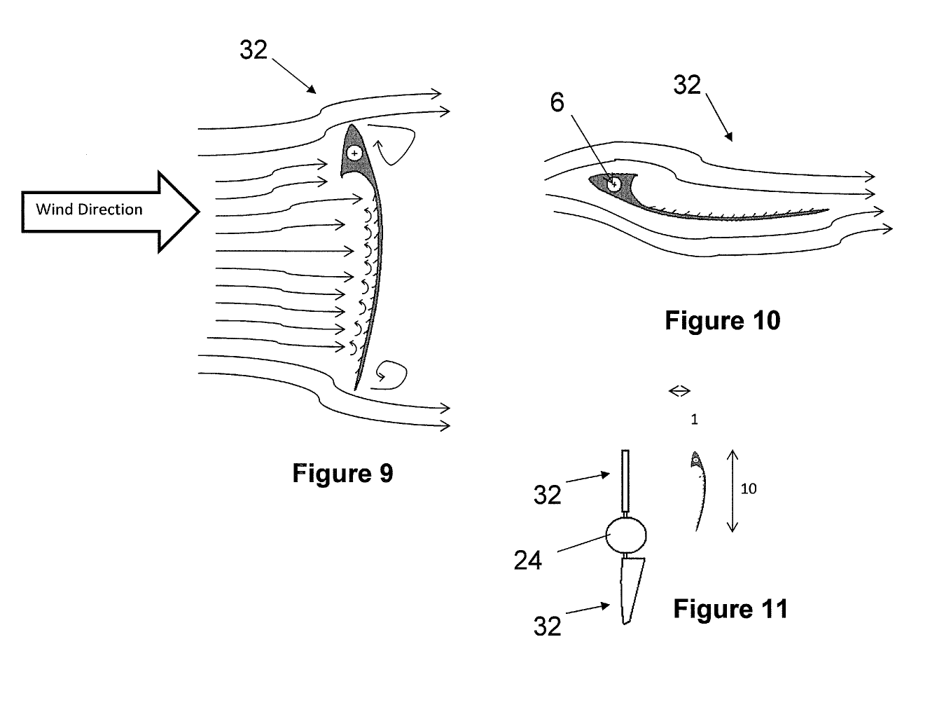

Turning to FIGS. 9 to 11, with an aspect ratio of 10:1 as shown in FIG. 11, the retreating blade force can be up to 10 times the trailing blade force due to the aspect ratio alone, and with 8 times the aerodynamic drag coefficient Cd, the leading blade anti-torque can become negligible. For example:

T_{retreating}=(1 m)(0.5)(1.2 kg/m3)(1 m/s)2(1.0 m2)(1.6)=0.960 Nm.

T_{leading}=(1 m)(0.5)(1.2 kg/3)(1 m/s)2(0.1 m2)(0.2)=0.012 Nm.

In the example shown in FIG. 9, the retreating blade aspect has a wind drag coefficient μ=1.6. The leading blade aspect shown in FIG. 10 assumes a wind drag coefficient μ=0.2. The output torque in the example shown in FIGS. 9 and 10 can be computed as follows:

Torqueₒᵤₜₚᵤₜ=L_{avg}×0.5×ρ×ν²^{_{wind}}×(A_{retreating}×Cd_{retreating}×Cd_{leading}).

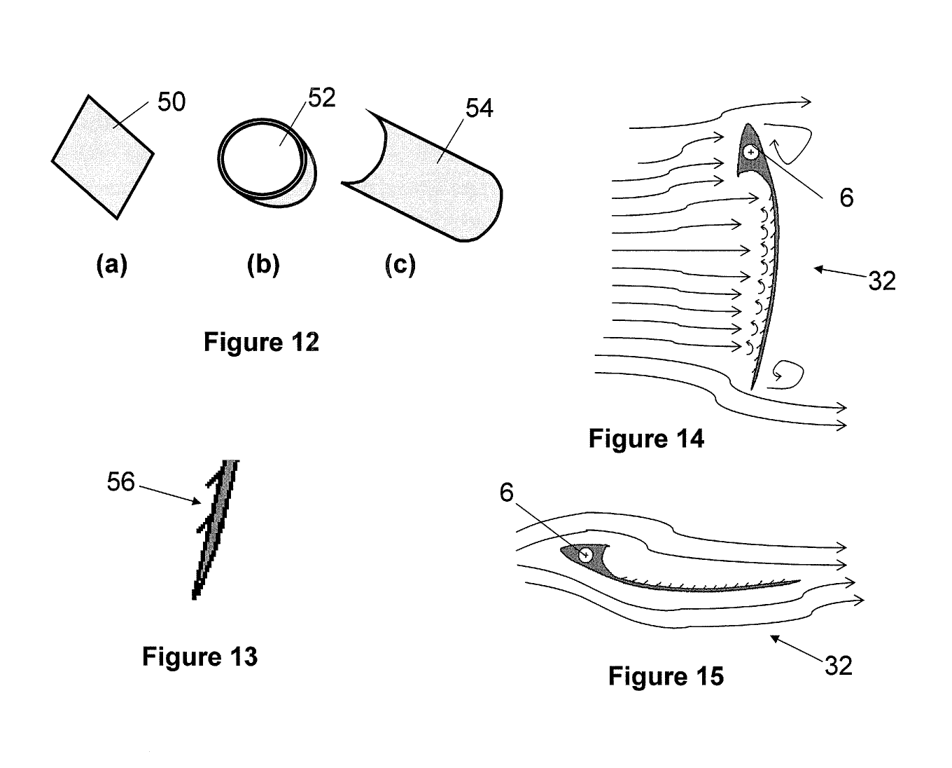

FIGS. 12(a) to 12(c) illustrate square plate 50, half sphere 52 and infinitely long cup 54 geometries are shown, which have been found can have wind drag coefficients of μ=1.0, μ=1.42, and μ=1.98 respectively. As such, it can be appreciated that the drag coefficient can vary based on the chosen geometry.

The principles discussed herein can also be made more effective when the Cd of leading and trailing blades is more extreme from each other. As illustrated in FIGS. 12 to 15, long channels such as the infinitely long cup-shape or ribbing of FIG. 12c can be used to maximize a high drag coefficient for the blade orientation in airflow shown in FIG. 14. The opposite surface minimizes drag when the blade is in the leading orientation to the airstream as shown in FIG. 15. And further, the use of airflow deflecting features such as angled ribs 56 to move air past high drag surfaces.

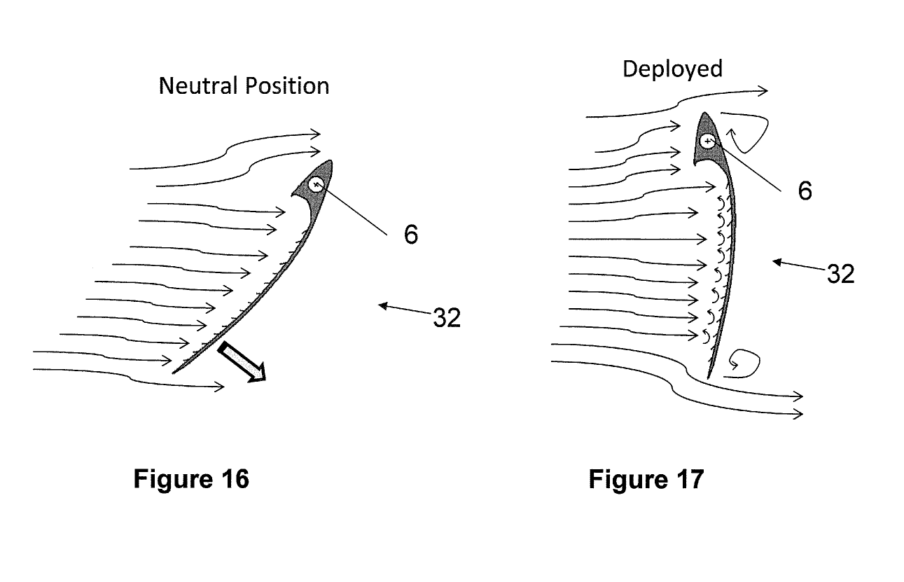

Turning to FIGS. 16 and 17, without any wind, the 90 degree offset blades naturally rest in the neutral position shown under their own weight or biasing force such as a spring force. With wind, the force acting on the blades to deploy the retreating blade, and retract the retreating blade, the optimum aspect for generating high output torque.

Although the above principles have been described with reference to certain specific embodiments, various modifications thereof will be apparent to those skilled in the art without departing from the scope of the claims appended hereto.

1. A turbine assembly comprising:
a rotatable member, rotatable about a turbine axis; and
at least one pair of blades, each blade being rotatably connected to the rotatable member and defining a respective blade axis, wherein each blade is rotatable about the turbine axis and rotatable about a respective blade axis.

2. The assembly according to claim 1, wherein each blade comprises an edge aligned with the respective blade axis such that the blade self-orients to a neutral position under its own weight or centering force.

3. The assembly according to claim 1, wherein a portion of each blade provides a control surface angled with respect to a primary surface to inhibit meta-stable stall of the respective blade in an fluid stream.

4. The assembly according to claim 1, comprising two pairs of blades.

5. The assembly according to claim 1, wherein the rotatable member comprises a hub connectable to a rotatable shaft, wherein each blade is connected to the hub.

6. The assembly according to claim 1, wherein each blade comprises a primary surface configured to oppose an fluid stream, the primary surface comprising a surface treatment to increase its drag coefficient.

7. The assembly according to claim 6, wherein the surface treatment comprises any one or more of: concave slots, hemispherical indentations, textures, particulates, grain or ribs.

8. The assembly according to claim 6, wherein each blade comprises an oppositely facing surface from the primary surface, the oppositely facing surface being provided with a surface treatment to reduce its drag coefficient.

9. The assembly according to claim 8, wherein the surface treatment on the oppositely facing surfaces comprises any one or more of: a smooth low-friction coating, film, spoiler or vortex generator.

10. The assembly according to claim 1, comprising a plurality of units, each unit comprising at least one pair of blades, the units being stacked vertically such that pairs of blades rotate about the rotating member either above or below another pair of blades.

11. A turbine blade comprising a first end providing a rotatable attachment for attaching the blade to a rotatable member and defining a blade axis, wherein the blade is rotatable about the blade axis while being rotatable about an axis defined by the rotatable member.

12. The blade according to claim 11, wherein the blade comprises an edge aligned with the blade axis such that the blade self-orients to a neutral position under its own weight.

13. The blade according to claim 11, wherein a portion of the blade provides a control surface angled with respect to a primary surface to inhibit meta-stable stall of the blade in an fluid stream.

14. The blade according to claim 11, wherein the blade comprises a primary surface configured to oppose an fluid stream, the primary surface comprising a surface treatment to increase its drag coefficient.

15. The blade according to claim 14, wherein the surface treatment comprises any one or more of: concave slots, hemispherical indentations, textures, particulates, grain or ribs.

16. The blade according to claim 14, wherein the blade comprises an oppositely facing surface from the primary surface, the oppositely facing surface being provided with a surface treatment to reduce its drag coefficient.

17. The blade according to claim 16, wherein the surface treatment on the oppositely facing surfaces comprises any one or more of: a smooth low-friction coating, film, spoiler or vortex generator.

18. The blade according to claim 1, wherein the blade comprises a linkage enabling the blade to be folded.
